(19) United States
(12) Patent Application Publication
(10) Pub. No.: US 2026/0102295 A1
(43) Pub. Date: Apr. 16, 2026

(54) Reclining Wheelchair Device

(71) Applicants: Samuel Randolph, Studio City, CA (US); J'uan Randolph, Studio City, CA (US)

(72) Inventors: Samuel Randolph, Studio City, CA (US); J'uan Randolph, Studio City, CA (US)

(21) Appl. No.: 18/915,963

(22) Filed: Oct. 15, 2024

(51) Int. Cl. A61G 5/00; A47C 1/024; A47C 7/50; A61G 5/04; A61G 5/10; A61G 5/12; B60L 53/16

(52) U.S. Cl. CPC A61G 5/006; A47C 1/024; A47C 7/5068; A61G 5/043; A61G 5/1013; A61G 5/1067; A61G 5/1083; A61G 5/127; A61G 5/128; B60L 53/16; A61G 2203/14; B60L 2200/24

(57) ABSTRACT

A reclining wheelchair device for facilitating mobility of individuals who are laying down includes a lower frame. An upper frame is pivotably coupled to the lower frame wherein the upper frame is selectively positionable in a vertical position and a horizontal position. The upper frame extends outwardly from the lower frame wherein the upper frame is coplanar with the lower frame when the upper frame is in the horizontal position. The upper frame and the lower frame are designed to support a body of a user while the user is lying down. A seat is coupled to the lower frame to support the body of the user. A back rest is coupled to the upper frame to support the body of the user. A plurality of wheels is rotatably mounted to the lower frame to facilitate movement of the lower frame and the upper frame.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to wheelchairs and more particularly pertains to a new wheelchair for facilitating mobility of individuals who are laying down.

### (2) Description of Related Art Including Information Disclosed Under 37 CFR 1.97 and 1.98

The prior art relates to wheelchairs. Wheelchairs are widely used tools that facilitate mobility of individuals who have mobility restrictions, such as physical disabilities, injuries, or illnesses. However, wheelchairs typically require users to sit up, in either an upright or a reclined position, and do not allow users to lay down. Wheelchairs accordingly have limited utility, particularly for individuals who are bedridden, or who are otherwise unable to sit up for extended periods of time. There is thus a need in the art for a wheelchair that would allow users to lay down.

### (H) BRIEF SUMMARY OF THE INVENTION

An embodiment of the disclosure meets the needs presented above by generally comprising a lower frame. An upper frame is pivotably coupled to the lower frame wherein the upper frame is selectively positionable in a vertical position and a horizontal position. The upper frame extends outwardly from the lower frame wherein the upper frame is coplanar with the lower frame when the upper frame is in the horizontal position. The upper frame and the lower frame are configured to support a body of the user while the user is lying down. A seat is coupled to the lower frame wherein the seat is configured to support the body of the user. A back rest is coupled to the upper frame wherein the back rest is configured to support the body of the user. A plurality of wheels is rotatably mounted to the lower frame to facilitate movement of the lower frame and the upper frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a reclining wheelchair device according to an embodiment of the disclosure.

FIG. 2 is a back isometric view of an embodiment of the disclosure.

FIG. 3 is a side view of an embodiment of the disclosure.

FIG. 4 is an in-use view of an embodiment of the disclosure.

FIG. 5 is a front view of an embodiment of the disclosure.

FIG. 6A is a back view of an embodiment of the disclosure.

FIG. 6B is a back view of an embodiment of the disclosure.

FIG. 6C is a back view of an embodiment of the disclosure.

FIG. 7 is a side view of an embodiment of the disclosure.

FIG. 8 is a side view of an embodiment of the disclosure.

FIG. 9 is a detail view of an embodiment of the disclosure.

FIG. 10 is a cross-sectional view of an embodiment of the disclosure.

FIG. 11 is a bottom detail view of an embodiment of the disclosure.

FIG. 12 is a top view of an embodiment of the disclosure.

FIG. 13 is a detail view of an embodiment of the disclosure.

FIG. 14 is a top view of an embodiment of the disclosure.

FIG. 15 is a side view of an embodiment of the disclosure.

FIG. 16 is a detail view of an embodiment of the disclosure.

FIG. 17 is a detail view of an embodiment of the disclosure.

FIG. 18 is a detail view of an embodiment of the disclosure.

### (J) DETAILED DESCRIPTION OF THE INVENTION

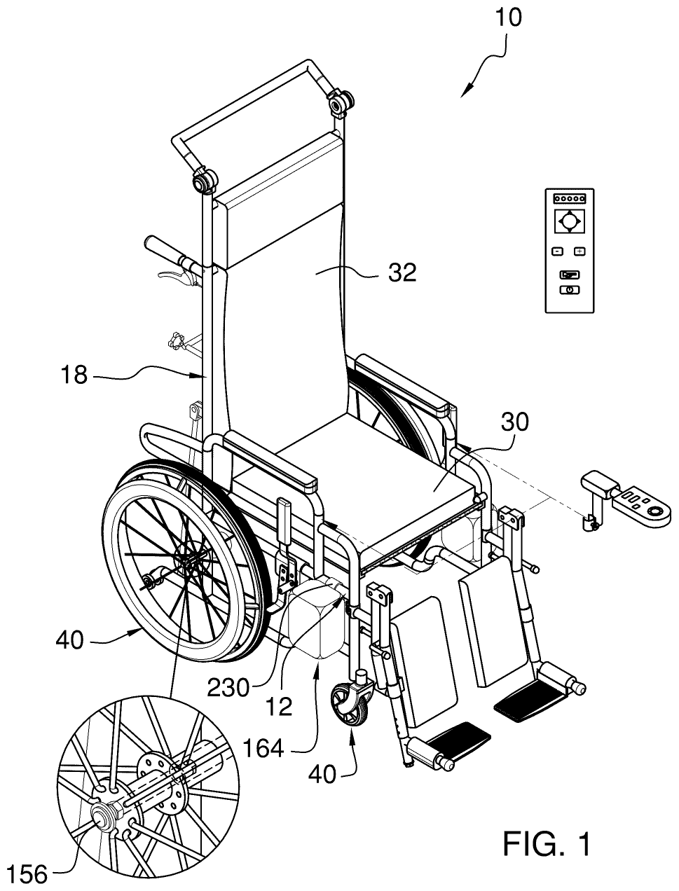

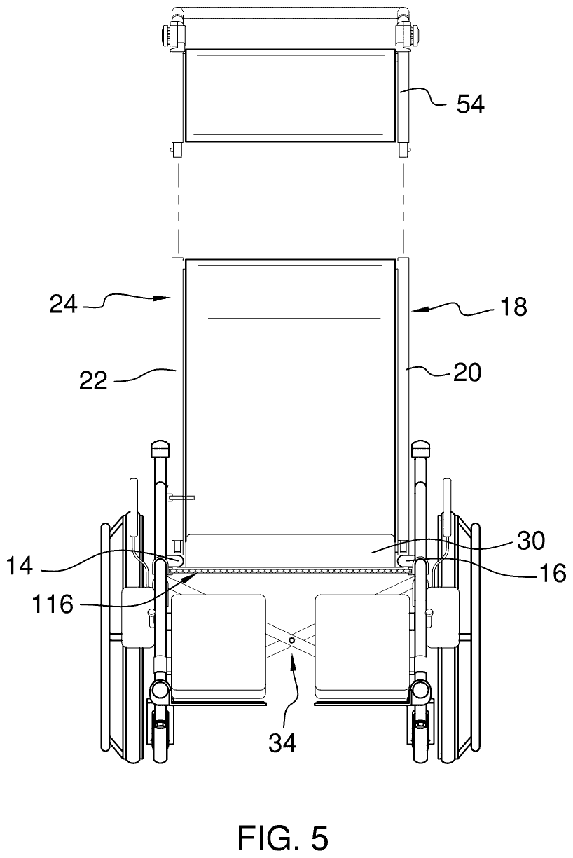

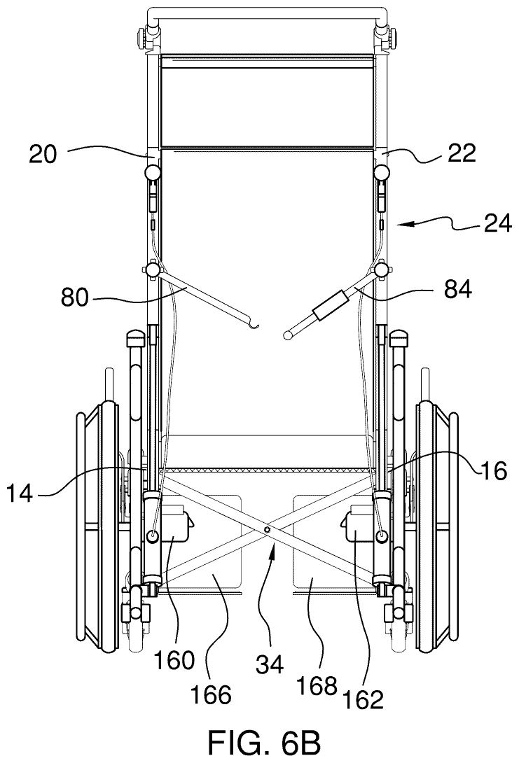

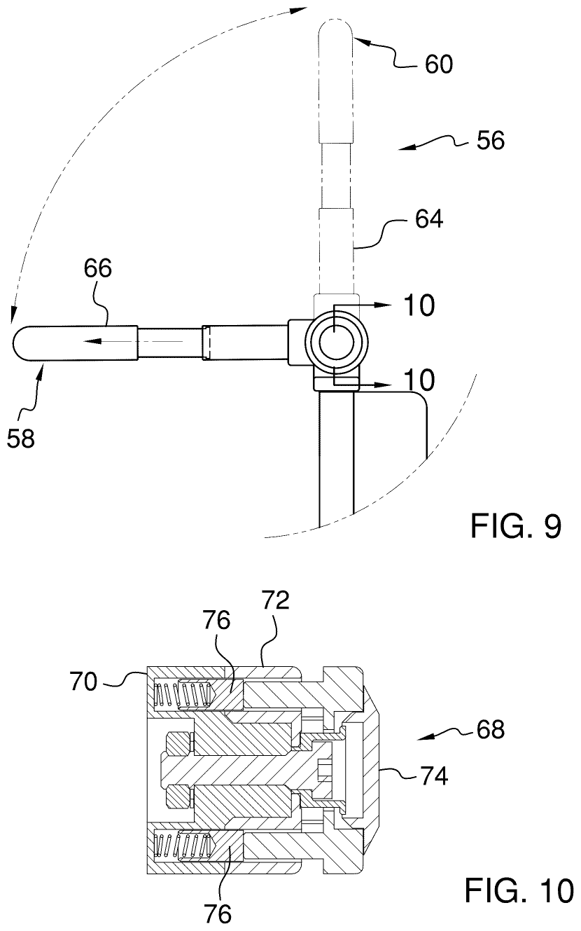

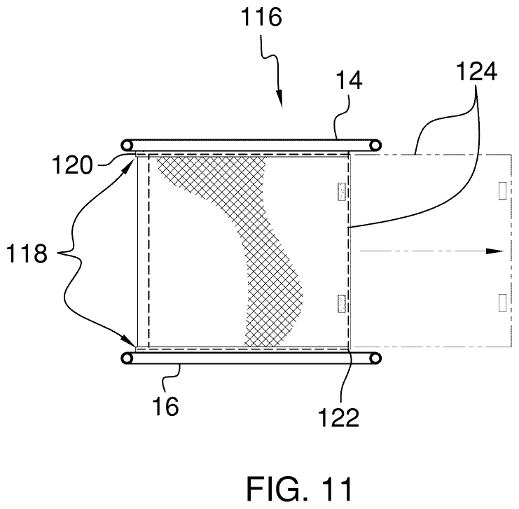

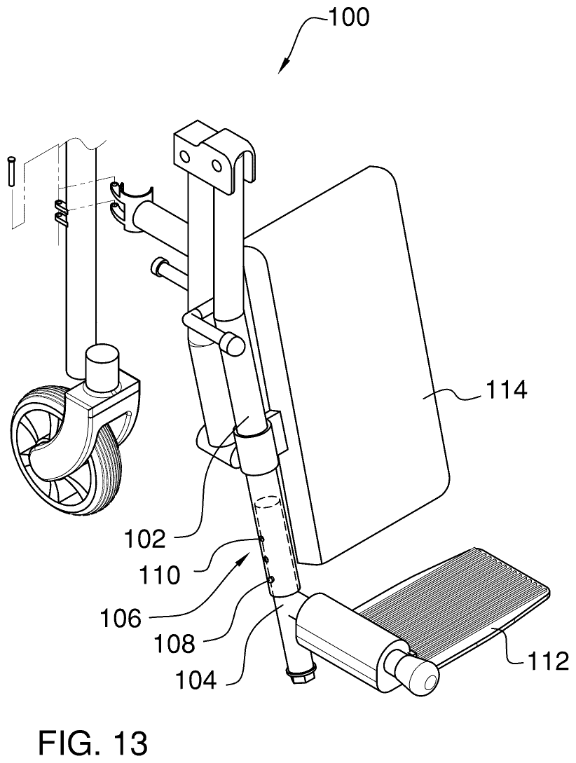

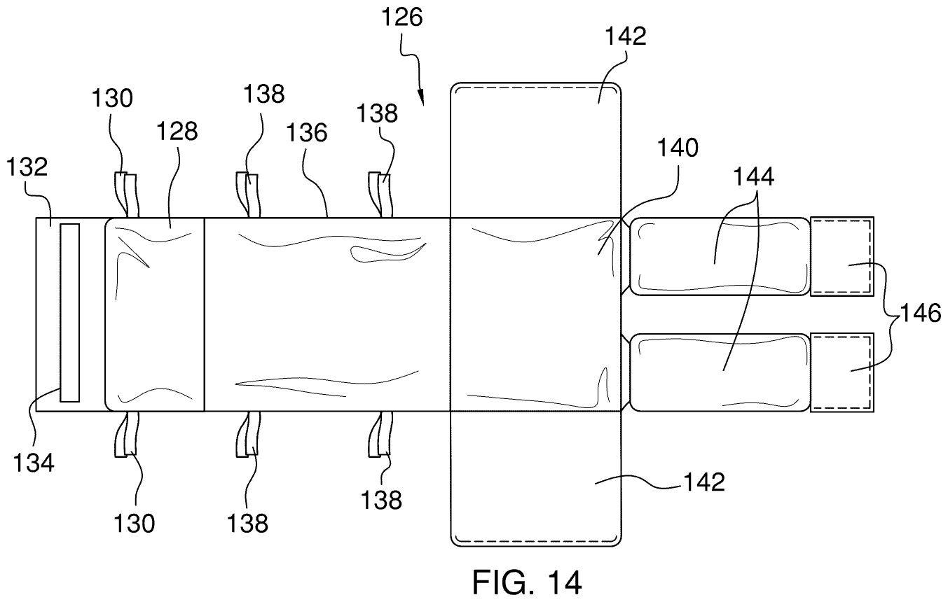

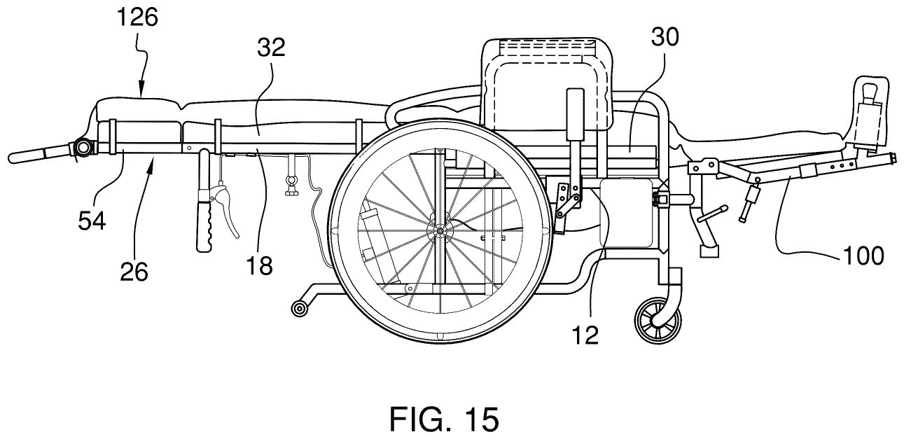

With reference now to the drawings, and in particular to FIGS. 1 through 18 thereof, a new wheelchair embodying the principles and concepts of an embodiment of the disclosure and generally designated by the reference numeral 10 will be described.

As best illustrated in FIGS. 1 through 18, the reclining wheelchair device 10 generally comprises a lower frame 12, for example having a lower frame first lateral side and a lower frame second lateral side 16.

An upper frame 18 is coupled to the lower frame 12. The upper frame 18 may have an upper frame first lateral side 20 and an upper frame second lateral side 22. The upper frame first lateral side 20 is generally aligned with the lower frame first lateral side 14. The upper frame second lateral side 22 is generally aligned with the lower frame second lateral side 16.

The upper frame 18 is pivotably coupled to the lower frame 12. Specifically, the upper frame 18 is selectively positionable in a vertical position 24 and a horizontal position 26. The upper frame 18 extends upwardly from the lower frame 12 when the upper frame 18 is in the vertical position 24. For example, the upper frame 18 may be perpendicular to the lower frame 12 when the upper frame 18 is in the vertical position 24. The upper frame 18 extends outwardly from the lower frame 12 wherein the upper frame 18 is coplanar with the lower frame 12 when the upper frame 18 is in the horizontal position 26. For example, the upper frame 18 may be parallel to the lower frame 12 when the upper frame 18 is in the horizontal position 26.

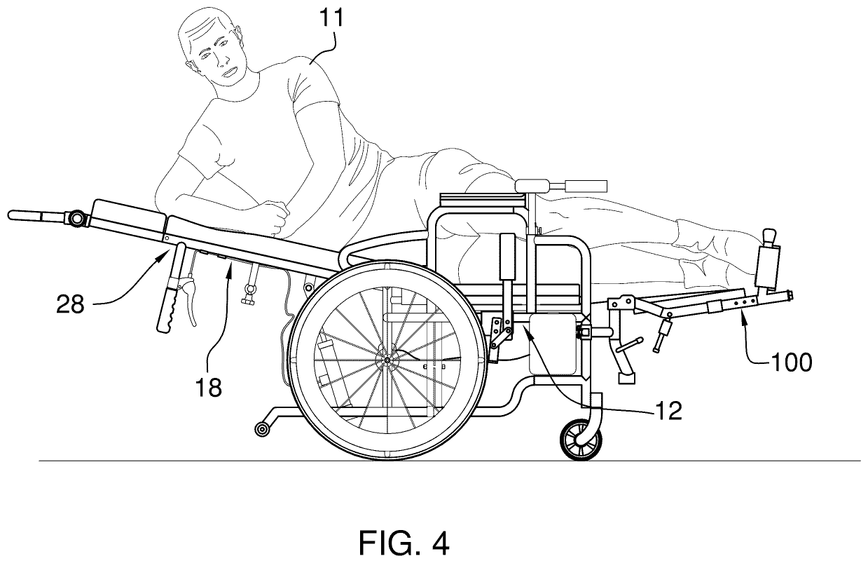

The upper frame 18 may also be selectively positionable in one or more intervening positions 28. The one or more intervening positions 28 are each between the vertical position 24 and the horizontal position 26. The upper frame 18 and the lower frame 12 are configured to support a body of a user 11 when the user 11 is sitting, laying down, or reclining in a position that is between sitting and laying down, for example as shown in FIG. 4.

A seat 30 may be coupled to the lower frame 12. For example, the seat 30 may extend between the lower frame first lateral side 14 and the lower frame second lateral side 16. The seat 30 is generally configured to support a body of a user 11 on the lower frame 12.

A back rest 32 may be coupled to the upper frame 18. For example, the back rest 32 may extend between the upper frame first lateral side 20 and the upper frame second lateral side 22. The back rest 32 is generally configured to support the body of the user 11.

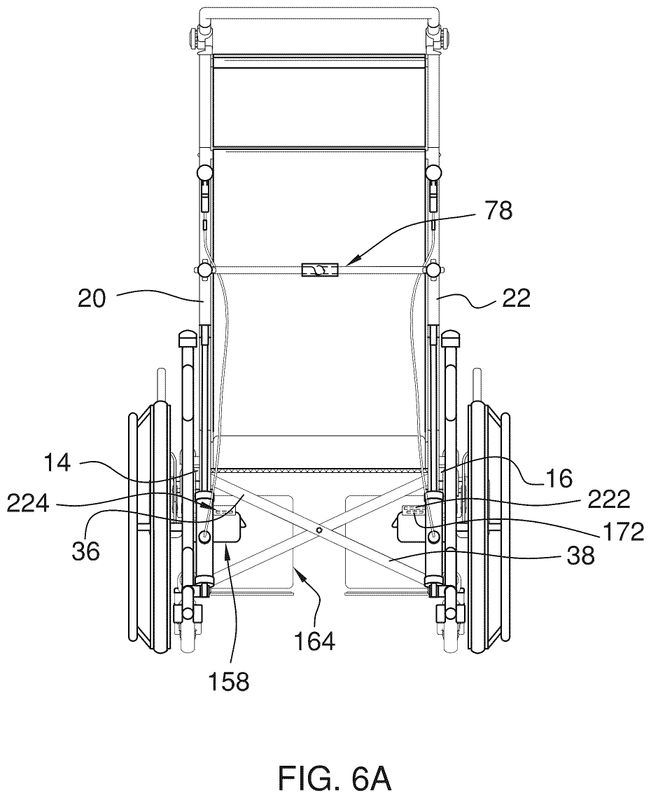

A pair of struts 34 may be pivotably coupled to the lower frame 12. For example, the pair of struts 34 may extend between the lower frame first lateral side 14 and the lower frame second lateral side 16. The pair of struts 34 may be pivotable to reduce a distance between the lower frame first lateral side 14 and the lower frame second lateral side 16 wherein the pair of struts 34 are configured to enable folding of the lower frame 12, for example to facilitate storage or transport of the reclining wheelchair device 10. The upper frame first lateral side 20 may be coupled to the lower frame first lateral side 14 and the upper frame second lateral side 22 may be coupled to the lower frame second lateral side 16 wherein pivoting the pair of struts 34 to reduce the distance between the lower frame first lateral side 14 and the lower frame second lateral side 16 also reduces a distance between the upper frame first lateral side 20 and the upper frame second lateral side 22. FIG. 6C provides an example of how the pair of struts 34 may facilitate collapsing the lower frame 12 and the upper frame 18.

The pair of struts 34 may include a first strut 36 that is angled to extend outwardly from the lower frame first lateral side 14 and downwardly toward the lower frame second lateral side 16. A second strut 38 may be angled to extend outwardly from the lower frame first lateral side 14 and upwardly toward the lower frame second lateral side 16. The second strut 38 may be pivotably coupled to the first strut 36. For example, the pair of struts 34 may intersect each other to define an X-shape positioned between the lower frame first lateral side 14 and the lower frame second lateral side 16.

A plurality of wheels 40 may be rotatably mounted to the lower frame 12 to facilitate movement of the lower frame 12 and the upper frame 18. For example, a pair of front wheels 42 may be coupled to the lower frame 12. The pair of front wheels 42 may be pivotably coupled to the lower frame 12, for example to allow each front wheel of the pair of front wheels 42 to pivot, or swivel, to facilitate turning the reclining wheelchair device 10. Each front wheel of the pair of front wheels 42 may be aligned with a respective one of the lower frame first lateral side 14 and the lower frame second lateral side 16.

A pair of drive wheels 44 may be spaced from the pair of front wheels 42. The pair of drive wheels 44 is generally positioned proximate to a junction between the lower frame 12 and the upper frame 18. For example, the user 11 may manually rotate the pair of drive wheels 44 to move the lower frame 12 and the upper frame 18 while the user 11 is sitting on the seat 30 that is coupled to the lower frame 12. Accordingly, the lower frame 12 is generally positioned between the pair of drive wheels 44 wherein a first drive wheel of the pair of drive wheels 44 is coupled to the lower frame first lateral side 14 and wherein a second drive wheel of the pair of drive wheels 44 is coupled to the lower frame second lateral side 16. The pair of drive wheels 44 may have a diameter exceeding a diameter of the pair of front wheels 42, for example wherein the pair of drive wheels 44 are configured to be within easy reach of the user 11 when the user 11 is sitting on the seat 30.

The pair of drive wheels 44 may further include a plurality of interchangeable wheels 148 being releasably couplable to the lower frame 12. Each interchangeable wheel of the plurality of interchangeable wheels 148 generally has a uniform diameter, namely, the diameter of the pair of drive wheels 44 described above. In such embodiments, the plurality of interchangeable wheels 148 of the pair of drive wheels 44 are each configured to be within easy reach of the user 11 while the user 11 is sitting on the seat 30.

The plurality of interchangeable wheels 148 are generally configured to facilitate movement of the lower frame 12 and the upper frame 18 across a plurality of terrains. For example, the plurality of terrains may include dirt, gravel, sand, snow, or grass. Embodiments of the plurality of interchangeable wheels 148 may include a standard tire 150. A treaded tire 152 may have a width that exceeds a width of the standard tire 150. The treaded tire 152 may have a treaded surface 226 that is configured to increase friction between the treaded tire 152 and an associated terrain of the plurality of terrains. For example, the treaded tire 152 may be preferred when the lower frame 12 and the upper frame 18 are being moved across dirt and gravel. A smooth tire 154 may also be included in the plurality of interchangeable wheels 148. The smooth tire 154 may have a smooth surface 228 that is configured to facilitate movement across the associated terrain of the plurality of terrains. For example, the smooth tire 154 may be preferred when the lower frame 12 and the upper frame 18 are being moved across sand and grass. The smooth tire 154 generally has a width exceeding the width of the standard tire 150. The smooth tire 154 may also have a width exceeding the width of the treaded tire 152.

A pair of rear wheels 46 may be spaced from the pair of drive wheels 44. For example, the pair of drive wheels 44 may be positioned between the pair of front wheels 42 and the pair of rear wheels 46. The pair of front wheels 42 may have a diameter exceeding a diameter of the pair of rear wheels 46. The pair of rear wheels 46 may be positioned beneath the upper frame 18 when the upper frame 18 is in the horizontal position 26 wherein the pair of rear wheels 46 are configured to inhibit the upper frame 18 from tipping over when the upper frame 18 is in the horizontal position 26.

A quick release pin 156 may releasably couple each drive wheel of the pair of drive wheels 44 to the lower frame 12. In other words, the quick release pin 156 may include a pair of quick release pins wherein each quick release pin 156 releasably couples a respective drive wheel of the pair of drive wheels 44 to the lower frame 12. For example, the quick release pin 156 may be releasably engageable with the respective drive wheel of the pair of drive wheels 44 and with the lower frame 12 to releasably secure the respective drive wheel of the pair of drive wheels 44 to the lower frame 12. The quick release pin 156 is configured to facilitate the user 11 in removing the pair of drive wheels 44 to swap out the plurality of interchangeable wheels 148. For example, the user 11 may remove the quick release pin 156 to decouple the standard tire 150 from the lower frame 12 and replace the standard tire 150 with either the treaded tire 152 or the smooth tire 154.

A brake 48 may be coupled to the lower frame 12. The brake 48 may be releasably engageable with the pair of drive wheels 44 to inhibit rotation of the pair of drive wheels 44. For example, a pair of brake levers 50 may each be pivotably coupled to a respective one of the lower frame first lateral side 14 and the lower frame second lateral side 16. A brake pad 52 may be coupled to each brake lever of the pair of brake levers 50. The brake pad 52 may be positionable against a respective drive wheel of the pair of drive wheels 44 to inhibit the respective drive wheel from being rotated when each brake lever of the pair of brake levers 50 is pivoted downwardly. The brake pad 52 may be spaced from the respective drive wheel of the pair of drive wheels 44 to enable the respective drive wheel to be rotated when each brake lever of the pair of brake levers 50 is pivoted upwardly.

A head rest 54 may be removably couplable to the upper frame 18. The head rest 54 is positionable on the upper frame 18 distally to the lower frame 12 wherein the head rest 54 is configured to support a head of the user 11. The head rest 54 is generally parallel to the upper frame 18 when the head rest 54 is coupled to the upper frame 18. The head reset 54 may be coplanar with the upper frame 18 when the head rest 54 is coupled to the upper frame 18.

A handle 56 may be coupled to and extend from the head rest 54. The handle 56 is generally configured to facilitate movement of the upper frame 18 and the lower frame 12 when the head rest 54 is coupled to the upper frame 18. For example, when the upper frame 18 is in the horizontal position 26, a person can hold onto the handle 56 to push the upper frame 18 and the lower frame 12 while the user 11 is resting on the seat 30 and the back rest 32.

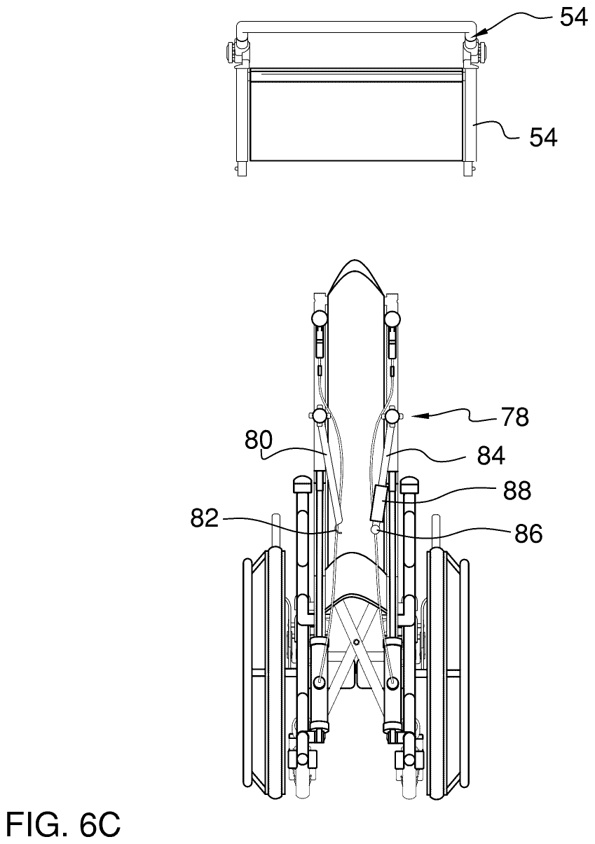

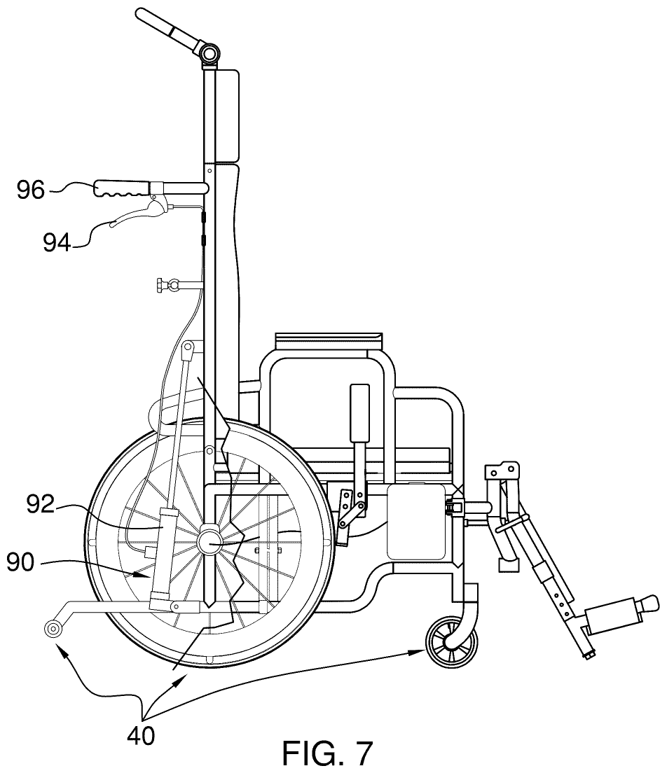

The handle 56 may be pivotably coupled to the head rest 54. For example, the handle 56 may be pivotable between a lowered position 58, a raised position 60, and an intermediate position 62 that is between the lowered position 58 and the raised position 60. The handle 56 may be perpendicular to the head rest 54 when the handle 56 is in the lowered position 58. The handle 56 may be parallel to the head rest 54 when the handle 56 is in the raised position 60. The handle 56 may be angled to extend outwardly and upwardly from the head rest 54 when the handle 56 is in the intermediate position 62. For example, FIG. 9 shows the handle 56 in each of the lowered position 58 and the raised position 60. FIG. 8 shows the handle 56 in the intermediate position 62. Some embodiments may include a single intermediate position 62, while other embodiments may include a plurality of intermediate positions.

The handle 56 may include a pair of handle primary members 64. Each handle primary member of the pair of handle primary members 64 may be aligned with a respective one of the upper frame first lateral side 20 and the upper frame second lateral side 22 when the head rest 54 is coupled to the upper frame 18. A handle secondary member 66 may be coupled to and extend between the pair of handle primary members 64. The handle secondary member 66 may be nested within each handle primary member of the pair of handle primary members 64 wherein the handle secondary member 66 is extendable and retractable relative to each handle primary member of the pair of handle primary members 64 to adjust the length of the handle 56.

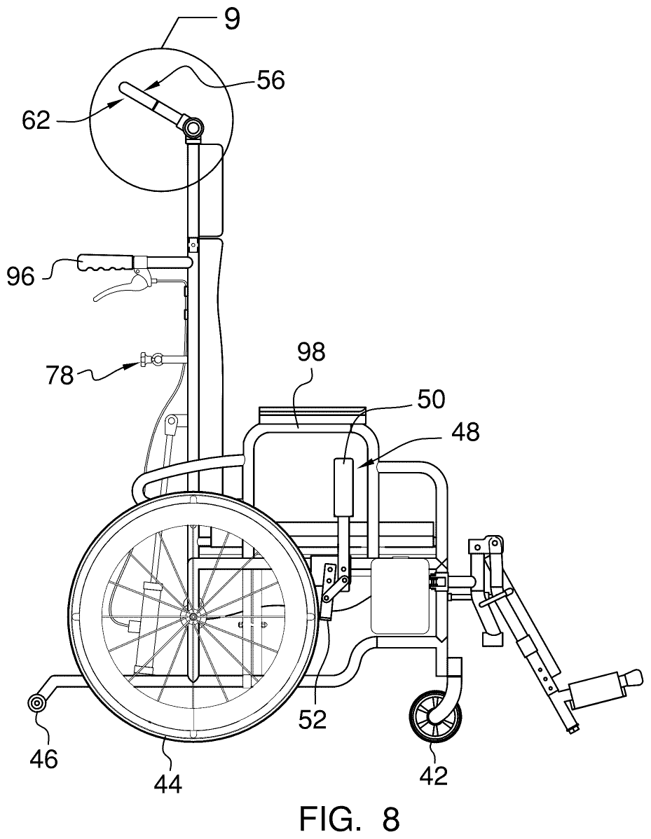

A handle lock 68 may be engageable with the handle 56 to releasably secure the handle 56 in one of the lowered position 58, the raised position 60, and the intermediate position 62. For example, a first chamber 70 may be coupled to and extend outwardly from the handle 56. The first chamber 70 may be positioned on at least one of the pair of handle primary members 64. A second chamber 72 may be pivotably coupled to the first chamber 70. The second chamber 72 may extend outwardly from the first chamber 70. A button 74 may be coupled to the second chamber 72. The button 74 may be positioned on the second chamber 72 distally to the first chamber 70. The button 74 may be actuatable to pivot the second chamber 72 relative to the first chamber 70. A locking pin 76 may be coupled to the second chamber 72. The locking pin 76 may be engageable with the first chamber 70 to inhibit the handle 56 from pivoting. For example, actuation of the button 74 may pivot the second chamber 72 such that the locking pin 76 can engage the first chamber 70, as shown in FIG. 10.

A support beam 78 may be coupled to the upper frame 18. The support beam 78 is generally extendable between the upper frame first lateral side 20 and the upper frame second lateral side 22 wherein the support beam 78 is configured to increase support for the user 11 when the upper frame 18 is in the horizontal position 26. The support beam 78 is generally spaced from the junction between the lower frame 12 and the upper frame 18.

The support beam 78 may include a support beam first rod 80 that may be pivotably coupled to the upper frame first lateral side 20. The support beam first rod 80 may include a hook 82 that is positioned distally to the upper frame first lateral side 20. A support beam second rod 84 may be pivotably coupled to the upper frame second lateral side 22. The support beam second rod 84 is releasably couplable to the support beam first rod 80 to extend the support beam 78 between the upper frame first lateral side 20 and the upper frame second lateral side 22. For example, the support beam second rod 84 may include a loop 86 that is positioned distally to the upper frame second lateral side 22. The hook 82 may engage the loop 86 to couple the support beam first rod 80 to the support beam second rod 84. A sleeve 88 may be slidably coupled to the support beam second rod 84. The sleeve 88 is generally positionable to cover the hook 82 and the loop 86 when the support beam first rod 80 is coupled to the support beam second rod 84 wherein the sleeve 88 is configured to inhibit the hook 82 from disengaging from the loop 86.

The support beam second rod 84 may be released from the support beam first rod 80 to facilitate folding of the lower frame 12 and the upper frame 18 for storage and transport. As shown in FIGS. 6B and 6C, the support beam first rod 80 and the support beam second rod 84 may hang from the upper frame first lateral side 20 and the upper frame second lateral side 22, respectively, when the support beam second rod 84 is released from the support beam first rod 80.

A lift mechanism 90 may be coupled to the upper frame 18 and the lower frame 12 to pivot the upper frame 18 between the vertical position 24 and the horizontal position 26 and the one or more intervening positions 28. For example, a pair of hydraulic pistons 92 may be coupled to the lower frame 12. Each hydraulic piston of the pair of hydraulic pistons 92 may be positioned on a respective one of the lower frame first lateral side 14 and the lower frame second lateral side 16. A pair of lift levers 94 may be operably coupled to the pair of hydraulic pistons 92 wherein actuation of the pair of lift levers 94 directs air through the pair of hydraulic pistons 92 to selectively pivot the upper frame 18 between the vertical position 24 and the horizontal position 26. Each lift lever of the pair of lift levers 94 may be positioned on a respective one of the upper frame first lateral side 20 and the upper frame second lateral side 22.

A pair of grips 96 may be coupled to and extend outwardly from the upper frame 18. The pair of grips 96 are configured to facilitate movement of the upper frame 18 and the lower frame 12, for example when the upper frame 18 is in the vertical position 24. Each grip of the pair of grips 96 may be coupled to a respective lift lever of the pair of lift levers 94 of the lift mechanism 90 to facilitate actuation of the lift mechanism 90. The pair of grips 96 may be positioned between the support beam 78 and the head rest 54 when the head rest 54 is coupled to the upper frame 18, wherein the pair of grips 96 are configured to be positioned between waist level and shoulder level for a person who is pushing the reclining wheelchair device 10.

A pair of arm rests 98 may be coupled to the lower frame 12. Each arm rest of the pair of arm rests 98 generally extends upwardly from a respective one of the lower frame first lateral side 14 and the lower frame second lateral side 16. The pair of brake levers 50 of the brake 48 may be positioned adjacent to the pair of arm rests 98 wherein the pair of brake levers 50 are configured to be accessible to the user 11 when the user is sitting on the seat 30.

A pair of leg rests 100 may be releasably couplable to the lower frame 12 wherein the pair of leg rests 100 are removable from the lower frame 12 to facilitate storage. The pair of leg rests 100 may be pivotably coupled to the lower frame 12. The pair of leg rests 100 may be coplanar with the lower frame 12 when the pair of leg rests 100 are pivoted upwards. The pair of leg rests 100 may be angled to extend downwardly and outwardly from the lower frame 12 when the pair of leg rests 100 are pivoted downwards.

Each leg rest of the pair of leg rests 100 may include a leg rest primary member 102. A leg rest secondary member 104 may be nested within the leg rest primary member 102 wherein the leg rest secondary member 104 is extendable and retractable relative to the leg rest primary member 102 to selectively adjust a length of each leg rest of the pair of leg rests 100.

A leg rest retainer 106 may be engageable with the leg rest primary member 102 and the leg rest secondary member 104 to releasably secure a position of the leg rest secondary member 104 relative to the leg rest primary member 102. For example, a detent 108 may be mounted on the leg rest secondary member 104 and may extend through one of a plurality of aligned apertures 110 that extend through the leg rest primary member 102.

A foot rest plate 112 may be pivotably coupled to the leg rest secondary member 104. The foot rest plate 112 may extend outwardly from the leg rest secondary member 104 wherein the foot rest plate 112 is configured to support a foot of the user 11. A calf pad 114 may be coupled to and extend outwardly from the leg rest primary member 102 wherein the calf pad 114 is configured to support a calf of a leg of the user 11.

A leg support 116 may be coupled to the lower frame 12. The leg support 116 may be slidable outwardly from the lower frame 12 wherein the leg support 116 is selectively positionable to extend between the seat 30 and the pair of leg rests 100, for example when the pair of leg rests 100 are pivoted upwards.

The leg support 116 may include a track 118 that is coupled to the lower frame 12. The track 118 may be positioned beneath the seat 30. For example, the track 118 may include a first rail 120 that is coupled to the lower frame first lateral side 14 and a second rail 122 that is coupled to the lower frame second lateral side 16. A panel 124 may be slidably coupled to the track 118. The panel 124 may extend between the first rail 120 and the second rail 122. The panel 124 may be slidable outwardly from beneath the seat 30 along the track 118 to position the panel 124 between the seat 30 and the pair of leg rests 100. The panel 124 may comprise a rigid material wherein the panel 124 is configured to support the pair of legs of the user 11 when the pair of leg rests 100 are pivoted upwards. The rigid material of the panel 124 may be foraminous, or a mesh material, wherein the rigid material is configured to facilitate airflow through the panel 124.

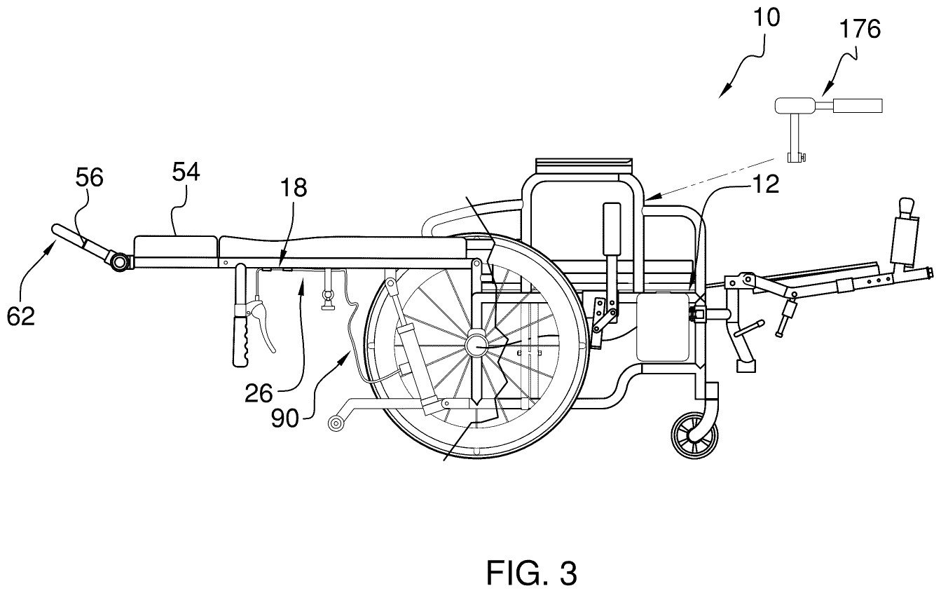

The lower frame 12, the upper frame 18, and the pair of leg rests 100 may be coplanar with each other when the upper frame 18 is in the horizontal position 26 and when the pair of leg rests 100 are pivoted upwards. FIGS. 3, 4, 12, and 15 provide exemplary embodiments, wherein the lower frame 12, the upper frame 18, and the pair of leg rests 100 are configured to support the body of the user 11 when the user 11 is laying down.

A mattress pad 126 may be removably couplable to one or more of the lower frame 12, the upper frame 18, the head rest 54 the pair of arm rests 98, and the pair of leg rests 100. The mattress pad 126 is configured to be positionable between the body of the user 11 and the one or more of the lower frame 12, the upper frame 18, the head rest 54, the pair of arm rests 98, and the pair of leg rests 100 to which the mattress pad 126 is coupled.

For example, a mattress head rest section 128 may be positionable on the head rest 54. A pair of head rest section fasteners 130 may be coupled to and extend from opposing lateral sides of the mattress head rest section 128 to releasably affix the mattress head rest section 128 to the head rest 54.

A hanger section 132 may be pivotably coupled to the mattress head rest section 128. The hanger section 132 generally extends outwardly from the mattress head rest section 128. The hanger section 132 may include a handle aperture 134 that is configured to receive the handle 56. In other words, the handle 56 may be positionable through the handle aperture 134 to couple the mattress pad 126 to the head rest 54. The hanger section 132 may comprise a fiber material that is flexible wherein the fiber material is configured to facilitate the hanger section 132 in pivoting upwardly and downwardly relative to the mattress head rest section 128.

A mattress back rest section 136 may be coupled to the mattress head rest section 128. The mattress back rest section 136 is generally positioned distally on the head rest 54 section relative to the hanger section 132. The mattress back rest section 136 is positionable on the upper frame 18. The mattress back rest section 136 may cover the back rest 32 when the mattress back rest section 136 is coupled to the upper frame 18. a plurality of back rest fasteners 138 may be coupled to and extend from opposing lateral sides of the mattress back rest section 136. Each back rest fastener of the plurality of back rest fasteners 138 may generally be configured to releasably engage a respective one of the upper frame first lateral side 20 and the upper frame second lateral side 22 to releasably affix the mattress back rest section 136 to the upper frame 18.

A mattress seat rest section 140 may be coupled to the mattress back rest section 136, for example distally to the mattress head rest section 128. The mattress seat rest section 140 is generally positionable on the lower frame 12. The mattress seat rest section 140 may extend from the mattress back rest section 136 wherein the mattress seat rest section 140 is positionable to cover the seat 30 when the mattress seat rest section 140 is coupled to the lower frame 12.

A pair of arm rest covers 142 may be pivotably coupled to opposing lateral edges of the mattress seat rest section 140. The pair of arm rest covers 142 are configured to be positionable over the pair of arm rests 98. The pair of arm rest covers 142 may comprise a fiber material that is flexible wherein the fiber material is configured to facilitate the pair of arm rest covers 142 in pivoting upwardly and downwardly relative to the mattress seat rest section 140.

A pair of mattress leg rest sections 144 may be pivotably coupled to the mattress seat rest section 140, for example distally to the mattress back rest section 136. The pair of mattress leg rest sections 144 are generally positionable on the pair of leg rests 100. For example, the pair of mattress leg rest sections 144 may cover the calf pad 114 of each leg rest of the pair of pair of leg rests 100 when the pair of mattress leg rest sections 144 are coupled to the pair of leg rests 100. Each leg rest of the pair of leg rests 100 may be upwardly and downwardly pivotable relative to the lower frame 12 when the pair of mattress leg rest sections 144 is positioned on the pair of leg rests 100.

A pair of foot sleeves 146 may be coupled to the pair of mattress leg rest sections 144. For example, the pair of foot sleeves 146 may be positioned on the pair of mattress leg rest sections 144 distally to the mattress seat rest section 140. The foot rest plate 112 of each leg rest of the pair of leg rests 100 is generally positionable within a respective foot sleeve of the pair of foot sleeves 146.

The mattress pad 126 may comprise a resiliently compressible material, for example, including foam padding and cooling gel. The resiliently compressible material of the mattress pad 126 is configured to facilitate comfort of the user 11. For example, the resiliently compressible material may provide lumbar and posture support to the user 11, may facilitate pressure redistribution across the body of the user 11, and may help to regulate a temperature of the body of the user 11.

A pair of motors 158 may be operably coupled to the pair of drive wheels 44. The pair of motors 158 are generally actuatable to rotate the pair of drive wheels 44 wherein the pair of motors 158 are configured to facilitate movement of the lower frame 12 and the upper frame 18. The pair of motors 158 may also be actuatable to pivot the pair of drive wheels 44 wherein the pair of motors 158 are configured to direct movement of the lower frame 12 and the upper frame 18. For example, the pair of motors 158 may pivot the pair of drive wheels 44 to the left and the right to turn the lower frame 12 and the upper frame 18 to the left and the right, respectively.

For example, the pair of motors 158 may include a first motor 160 that is operably coupled to the first drive wheel of the pair of drive wheels 44. The first motor 160 may be positioned on the lower frame first lateral side 14 beneath the seat 30. A second motor 162 may be operably coupled to the second drive wheel of the pair of drive wheels 44. The second motor may be positioned on the lower frame second lateral side 16 beneath the seat 30.

A motor power source 164 may be electrically coupled to the pair of motors 158. The motor power source 164 may include a pair of rechargeable batteries. For example, a first battery 166 may be releasably coupled to the lower frame first lateral side 14 and the first battery 166 may be electrically coupled to the first motor 160. A second battery 168 may be releasably coupled to the lower frame second lateral side 16 and the second battery 168 may be electrically coupled to the second motor 162.

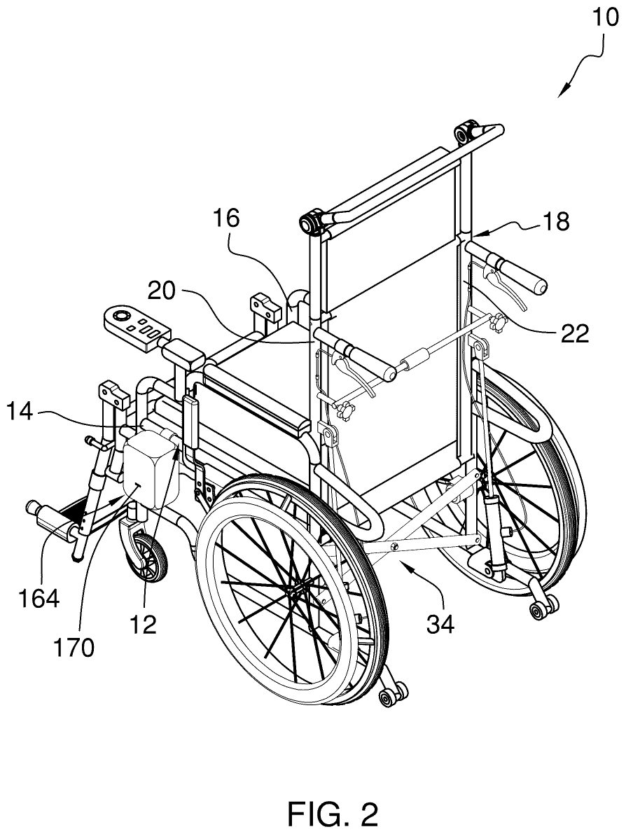

In one embodiment, the first battery 166 and the second battery 168 may each be removed from the lower frame 12 for recharging the motor power source 164. For example, straps 230 may releasably secure each battery of the motor power source 164 to the lower frame 12, as indicated in FIG. 1. Alternatively, a charging port 170 may be electrically coupled to the motor power source 164 to facilitate transfer of power from an external power source (such as a generator or an electrical outlet) to the motor power source 164. For example, the charging port 170 may be inset into each battery of the motor power source 164 and exposed within each battery of the motor power source 164, as indicated in FIG. 2. Some embodiments may include both the straps 230 and the charging port 170, providing the user 11 with more options for how to recharge the pair of rechargeable batteries.

A motor processor 172 may be electrically coupled to the motor power source 164. The motor processor 172 is generally electrically coupled to the pair of motors 158 wherein the motor processor 172 is actuatable to actuate the pair of motors 158. The motor processor 172 may be positioned within the first motor 160 of the pair of motors 158.

A control assembly 174 may be in wireless communication with the motor processor 172 wherein the control assembly 174 is actuatable to signal the motor processor 172 to actuate the pair of motors 158.

For example, the control assembly 174 may include a joystick 176, which may be removably couplable to a selectable arm rest of the pair of arm rests 98. For example, the user 11 may select which arm rest on which to position the joystick 176 based on the dominant hand of the user 11. The user 11 may position the joystick 176 on the right arm rest when the user 11 is right-handed, or the user 11 may position the joystick 176 on the left arm rest when the user 11 is left-handed.

The joystick 176 may include a clamp 178 that is positionable to engage the selectable arm rest of the pair of arm rests 98. A pole 180 may be coupled to and extend upwardly from the clamp 178. A wrist pad 182 may be coupled to and extend outwardly from the pole 180. The wrist pad 182 may have a planar upper surface 232 wherein the wrist pad 182 is configured to support a wrist of the user 11.

A joystick housing 184 may be coupled to and extend outwardly from the wrist pad 182. A joystick processor 186 may be positioned within the joystick housing 184. A joystick power source 188 may be electrically coupled to the joystick processor 186. For example, the joystick power source 188 may be a battery, such as a rechargeable battery. A joystick transmitter 190 may be electrically coupled to the joystick processor 186. The joystick transmitter 190 may send signals from the joystick processor 186 to the motor processor 172. For example, the joystick transmitter 190 may be in wireless communication with the motor processor 186.

A joystick directional control panel 192 may be positioned on the joystick housing 184 wherein the joystick directional control panel 192 is configured to be accessible to the user 11 while the wrist of the user 11 is supported on the wrist pad 182. The joystick directional control panel 192 may be electrically coupled to the joystick processor 186. The joystick directional control panel 192 may be actuatable to signal the pair of motors 158 to pivot the pair of drive wheels 44 to direct movement of the lower frame 12 and the upper frame 18.

A joystick speed control panel 194 may be positioned on the joystick housing 184 wherein the joystick speed control panel 194 is configured to be accessible to the user 11 while the wrist of the user 11 is supported on the wrist pad 182. The joystick speed control panel 194 may be electrically coupled to the joystick processor 186. The joystick speed control panel 194 may be actuatable to selectively adjust a speed at which the pair of motors 158 rotate the pair of drive wheels 44.

A joystick power button 196 may be positioned on the joystick housing 184 wherein the joystick power button 196 is configured to be accessible to the user 11 while the wrist of the user 11 is supported on the wrist pad 182. The joystick power button 196 may be electrically coupled to the joystick processor 186. The joystick power button 196 may be actuatable to turn the pair of motors 158 on and off.

A joystick horn button 198 may be positioned on the joystick housing 184 wherein the joystick horn button 198 is configured to be accessible to the user 11 while the wrist of the user 11 is supported on the wrist pad 182. The joystick horn button 198 may be electrically coupled to the joystick processor 186. The joystick horn button 198 may be actuatable to signal the joystick processor 186 to emit a horn sound that is stored on the joystick processor 186. A joystick speaker 200 may be electrically coupled to the joystick processor 186 wherein the joystick processor 186 is actuated to audibly emit the horn sound through the joystick speaker 200 when the joystick horn button 198 is pressed.

The control assembly 174 may also include a remote 202. The remote 202 may include a remote housing 204 that has a size that is configured to fit within the hand of the user 11 wherein the remote housing 204 is configured to be manipulated by the hand of the user 11. In other words, the remote housing 204 may be sized so that the user 11 can hold and manipulate the remote 202 with a single hand.

A remote processor 206 may be positioned within the remote housing 204. A remote power source 208 may be electrically coupled to the remote processor 206. For example, the remote power source 208 may be a battery, which may be rechargeable, located within the remote housing 204. A remote transmitter 210 may be electrically coupled to the remote processor 206. The remote transmitter 210 may send signals from the remote processor 206 to the motor processor 172. For example, the remote transmitter 210 may be in wireless communication with the motor processor 186.

A remote directional control panel 212 may be positioned on the remote housing 204 wherein the remote directional control panel 212 is configured to be accessible to the user 11 while the user 11 is holding the remote housing 204. The remote directional control panel 212 is generally electrically coupled to the remote processor 206. The remote directional control panel 212 is generally actuatable to signal the pair of motors 158 to pivot the pair of drive wheels 44 to direct movement of the lower frame 12 and the upper frame 18.

A remote speed control panel 214 may be positioned on the remote housing 204 wherein the remote speed control panel 214 is configured to be accessible to the user 11 while the user 11 is holding the remote housing 204. The remote speed control panel 214 is generally electrically coupled to the remote processor 206. The remote speed control panel 214 is generally actuatable to signal the pair of motors 158 to adjust the speed at which the pair of motors 158 rotate the pair of drive wheels 44.

A remote power button 216 may be positioned on the remote housing 204 wherein the remote power button 216 is configured to be accessible to the user 11 while the user 11 is holding the remote housing 204. The remote power button 216 is generally electrically coupled to the remote processor 206. The remote power button 216 may be actuatable to turn the pair of motors 158 on and off.

A remote horn button 218 may be positioned on the remote housing 204 wherein the remote horn button 218 is configured to be accessible to the user 11 while the user 11 is holding the remote housing 204. The remote horn button 218 is generally electrically coupled to the remote processor 206. The remote horn button 218 may be actuatable to signal the remote processor 206 to emit a horn sound that is stored on the horn processor 206. A remote speaker 220 may be electrically coupled to the remote processor 206 wherein the remote processor 206 is actuatable to audibly emit the horn sound through the remote speaker 220.

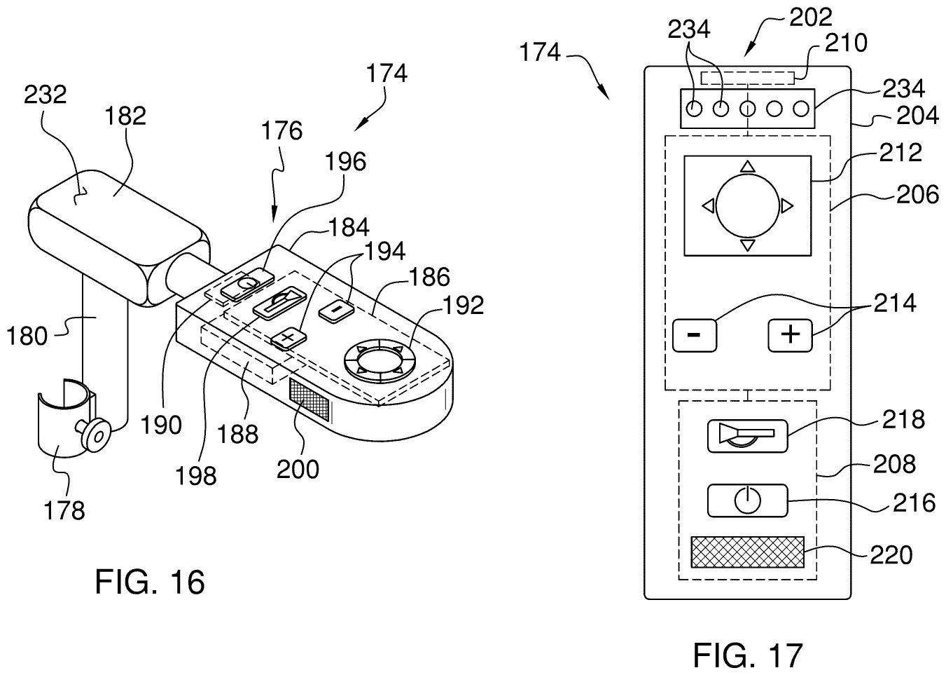

The remote 202 may also include a battery indicator 234 which is electrically coupled to the remote processor 206. The battery indicator 234 may generally be configured to display a power level of the remote power source 208. For example, the battery indicator 234 may include a plurality of lights 236. The plurality of lights 236 may be horizontally and vertically aligned with each other on the remote 202. When the remote power source 208 is fully charged, all lights of the plurality of lights 236 may be illuminated. As the remote power source 208 is depleted, one or more of the plurality of lights 236 may be turned off, corresponding to the amount of charge which remains in the remote power source 208. For example, when the remote power source 208 is only 80% charged, only four of the five lights of the plurality of lights 236 shown in FIG. 17 may be illuminated.

A motor transceiver 222 may be electrically coupled to the motor processor 172. The motor transceiver 222 is generally in wireless communication with the control assembly 174 wherein the motor transceiver 222 is configured to send signals to the control assembly 174 and to receive signals from the control assembly 174. The motor transceiver 222 may be positioned within the first motor 160 of the pair of motors 158.

A motor receiver 224 may be electrically coupled to the motor processor 172. The motor receiver 224 may be in wireless communication with the motor transceiver 222 wherein the motor receiver 224 is configured to receive signals from the motor transceiver 222. The motor receiver 224 may be positioned within the second motor 162 of the pair of motors 158.

In use, the reclining wheelchair device 10 allows the user 11 to sit up, lay down, and recline in positions that are between sitting up and laying down. Specifically, the reclining wheelchair device 10 facilitates mobility of the user 11 when the user 11 is unable to sit up for extended periods, and when the user 11 needs to remain laying down, for example because a medical condition of the user 11 requires the user 11 to remain on bed rest. The lift mechanism 90 can facilitate movement of the upper frame 18 relative to the lower frame 12, allowing the user 11 to move the upper frame 18 between the vertical position 24, the horizontal position 26, and the one or more intervening positions 28.

The seat 30 and the back rest 32 are able to support the user 11 on the lower frame 12 and the upper frame 18, respectively. The mattress pad 126 can be positioned over the lower frame 12 and the upper frame 18 to add padding for the user 11, for example to increase comfort when the user 11 is positioned in the reclining wheelchair device 10 for extended periods of time. The lift mechanism 90 may be used to adjust the angle of the upper frame 18 while the mattress pad 126 is coupled to the upper frame 18 and the lower frame 12. Similarly, the angle of the pair of leg rests 100 can also be adjusted when the mattress pad 126 is coupled to the pair of leg rests 100.

The handle 56 and the pair of grips 96 facilitate movement of the lower frame 12 and the upper frame 18. The handle 56 may be preferred by the user 11, or the person who is pushing the reclining wheelchair device 10, when the upper frame 18 is in the horizontal position 26, for example because the pair of grips 96 will be oriented downwards toward the ground and may be difficult to reach. The pair of grips 96 may be preferred by the user 11, or the person who is pushing the reclining wheelchair device 10, when the upper frame 18 is in the vertical position 24, for example because the pair of grips 96 are easy to reach.

Alternatively, the user 11 may use the control assembly 174 to actuate the pair of motors 158 to move the reclining wheelchair device 10. For example, the user 11 may use the joystick 176 or the remote 202 to facilitate movement of the lower frame 12 and the upper frame 18 without needing another individual to push the reclining wheelchair device 10.

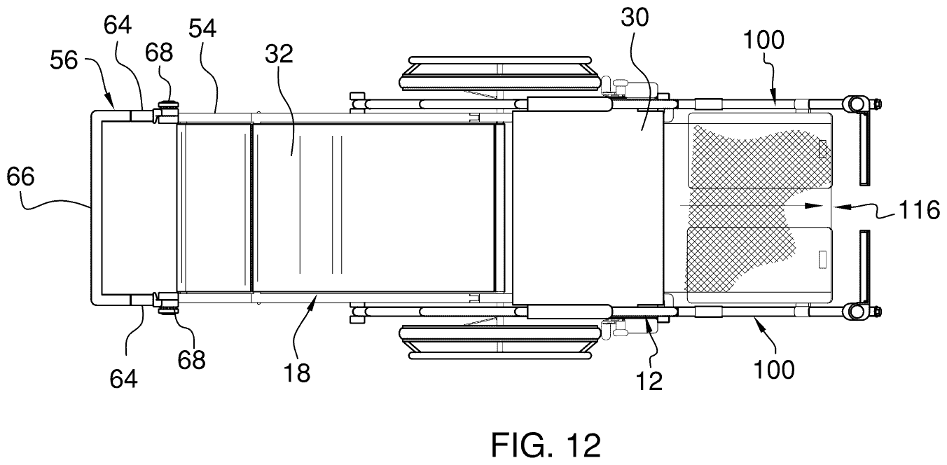

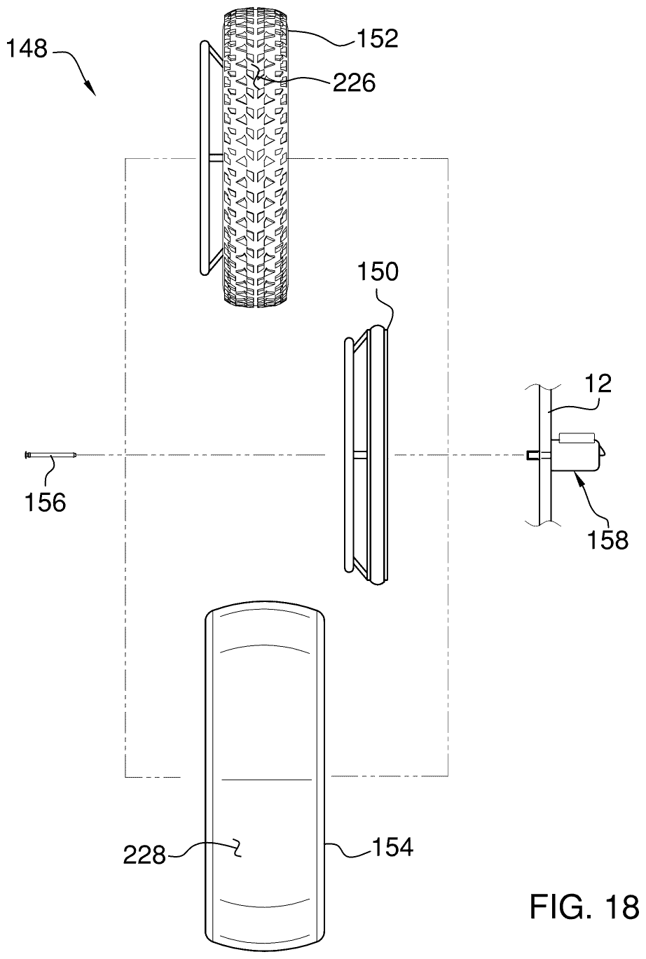

To facilitate storage and transport of the reclining wheelchair device 10, the head rest 54 may be removed from the upper frame 18. The support beam second rod 84 can also be decoupled from the support beam first rod 80. The pair of struts 34 may be pivoted to move the lower frame first lateral side 14 and the upper frame first lateral side 20 closer to the lower frame second lateral side 16 and the upper frame second lateral side 22, respectively, as shown in FIG. 6C. The pair of leg rests 100 may be removed from the lower frame 12, for example as shown in FIG. 13. The pair of drive wheels 44 may also be removed from the lower frame 12 by removing the quick release pin 156 as indicated in FIG. 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reclining wheelchair apparatus comprising:
a lower frame;
an upper frame being pivotably coupled to the lower frame wherein the upper frame is selectively positionable in a vertical position and a horizontal position, the upper frame extending outwardly from the lower frame wherein the upper frame is coplanar with the lower frame when the upper frame is in the horizontal position wherein the upper frame and the lower frame are configured to support a body of the user while the user is lying down;
a seat being coupled to the lower frame wherein the seat is configured to support the body of the user;
a back rest being coupled to the upper frame wherein the back rest is configured to support the body of the user; and
a plurality of wheels being rotatably mounted to the lower frame to facilitate movement of the lower frame and the upper frame.

2. The reclining wheelchair apparatus of claim 1, further comprising a pair of struts being pivotably coupled to the lower frame, the pair of struts extending between a lower frame first lateral side and a lower frame second lateral side of the lower frame, the pair of struts being pivotable to reduce a distance between the lower frame first lateral side and the lower frame second lateral side wherein the pair of struts are configured to enable folding of the lower frame to facilitate storage.

3. The reclining wheelchair apparatus of claim 2, the pair of struts further comprising:
a first strut being angled to extend outwardly from the lower frame first lateral side and downwardly toward the lower frame second lateral side; and
a second strut being angled to extend outwardly from the lower frame first lateral side and upwardly toward the lower frame second lateral side, the second strut being pivotably coupled to the first strut wherein the pair of struts define an X-shape positioned between the lower frame first lateral side and the lower frame second lateral side.

4. The reclining wheelchair apparatus of claim 1, the plurality of wheels further comprising:
a pair of front wheels being pivotably coupled to the lower frame;
a pair of drive wheels being spaced from the pair of front wheels, the pair of drive wheels being positioned proximate to a junction between the lower frame and the upper frame; and
a pair of rear wheels being spaced from the pair of drive wheels wherein the pair of drive wheels are positioned between the pair of front wheels and the pair of rear wheels, the pair of rear wheels being positioned beneath the upper frame when the upper frame is in the horizontal position wherein the pair of rear wheels are configured to inhibit the upper frame from tipping over when the upper frame is in the horizontal position.

5. The reclining wheelchair assembly of claim 4, further comprising a brake being coupled to the lower frame, the brake being releasably engageable with the pair of drive wheels to inhibit rotation of the pair of drive wheels.

6. The reclining wheelchair assembly of claim 1, further comprising a head rest being removably couplable to the upper frame, the head rest being positionable on the upper frame distally to the lower frame wherein the head rest is configured to support a head of the user.

7. The reclining wheelchair assembly of claim 6, further comprising a handle being coupled to and extending from the head rest.

8. The reclining wheelchair assembly of claim 7, wherein the handle is pivotably coupled to the head rest wherein the handle is pivotable between a lowered position and a raised position.

9. The reclining wheelchair assembly of claim 8, further comprising a handle lock being engageable with the handle to releasably secure the handle in one of the lowered position and the raised position.

10. The reclining wheelchair assembly of claim 7, the handle further comprising:
a pair of handle primary members; and
a handle secondary member being coupled to and extending between the pair of handle primary members, the handle secondary member being nested within each handle primary member of the pair of handle primary members wherein the handle secondary member is extendable and retractable relative to each handle primary member of the pair of handle primary members to adjust a length of the handle.

11. The reclining wheelchair assembly of claim 1, further comprising a support beam being coupled to the upper frame, the support beam being extendable between an upper frame first lateral side and an upper frame second lateral side of the upper frame wherein the support beam is configured to increase support for the user when the upper frame is in the horizontal position.

12. The reclining wheelchair assembly of claim 11, the support beam further comprising:
a support beam first rod being pivotably coupled to the upper frame first lateral side; and
a support beam second rod being pivotably coupled to the upper frame second lateral side, the support beam second rod being releasably couplable to the support beam first rod to extend the support beam between the upper frame first lateral side and the upper frame second lateral side.

13. The reclining wheelchair assembly of claim 12, the support beam first rod further comprising a hook being positioned distally to the upper frame first lateral side, the support beam second rod further comprising a loop being positioned distally to the upper frame second lateral side, the hook engaging the loop to couple the support beam first rod to the support beam second rod.

14. The reclining wheelchair assembly of claim 13, the support beam further comprising a sleeve being slidably coupled to the support beam second rod, the sleeve being positionable to cover the hook and the loop when the support beam first rod is coupled to the support beam second rod wherein the sleeve is configured to inhibit the hook from disengaging from the loop.

15. The reclining wheelchair assembly of claim 1, further comprising a pair of leg rests being pivotably coupled to the lower frame, the pair of leg rests being coplanar with the lower frame when the pair of leg rests are pivoted upwards, the pair of leg rests being angled to extend downwardly and outwardly from the lower frame when the pair of leg rests are pivoted downwards.

16. The reclining wheelchair assembly of claim 15, further comprising a leg support being coupled to the lower frame, the leg support being slidable outwardly from the lower frame wherein the leg support is selectively positionable to extend between the seat and the pair of leg rests when the pair of leg rests are pivoted upwards.

17. The reclining wheelchair assembly of claim 16, the leg support further comprising:
a track being coupled to the lower frame, the track being positioned beneath the seat;
a panel being slidably coupled to the track, the panel being slidable outwardly from beneath the seat along the track to position the panel between the seat and the pair of leg rests.

18. The reclining wheelchair assembly of claim 1, further comprising a mattress pad being removably couplable to the lower frame and the upper frame wherein the mattress pad is configured to be positionable between the body of the user and each of the lower frame and the upper frame.

19. The reclining wheelchair assembly of claim 18, the mattress pad further comprising:
a mattress back rest section being positionable on the upper frame, the mattress back rest section covering the back rest when the mattress back rest section is coupled to the upper frame; and
a mattress seat rest section being coupled to the mattress back rest section wherein the mattress seat rest section is positionable on the lower frame, the mattress seat rest section covering the seat when the mattress seat rest section is coupled to the lower frame.

20. A reclining wheelchair apparatus comprising:
a lower frame having a lower frame first lateral side and a lower frame second lateral side;
an upper frame being coupled to the lower frame, the upper frame having an upper frame first lateral side and an upper frame second lateral side, the upper frame first lateral side being aligned with the lower frame first lateral side, the upper frame second lateral side being aligned with the lower frame second lateral side, the upper frame being pivotably coupled to the lower frame wherein the upper frame is selectively positionable in a vertical position and a horizontal position, the upper frame extending upwardly from the lower frame when the upper frame is in the vertical position, the upper frame being perpendicular to the lower frame when the upper frame is in the vertical position, the upper frame extending outwardly from the lower frame wherein the upper frame is coplanar with the lower frame when the upper frame is in the horizontal position;
a seat being coupled to the lower frame, the seat extending between the lower frame first lateral side and the lower frame second lateral side wherein the seat is configured to support a body of a user;
a back rest being coupled to the upper frame, the back rest extending between the upper frame first lateral side and the upper frame second lateral side wherein the back rest is configured to support the body of the user;
a pair of struts being pivotably coupled to the lower frame, the pair of struts extending between the lower frame first lateral side and the lower frame second lateral side, the pair of struts being pivotable to reduce a distance between the lower frame first lateral side and the lower frame second lateral side wherein the pair of struts are configured to enable folding of the lower frame to facilitate storage, the pair of struts including:
a first strut being angled to extend outwardly from the lower frame first lateral side and downwardly toward the lower frame second lateral side; and
a second strut being angled to extend outwardly from the lower frame first lateral side and upwardly toward the lower frame second lateral side, the second strut being pivotably coupled to the first strut wherein the pair of struts define an X-shape positioned between the lower frame first lateral side and the lower frame second lateral side;
a plurality of wheels being rotatably mounted to the lower frame to facilitate movement of the lower frame and the upper frame, the plurality of wheels including:
a pair of front wheels being pivotably coupled to the lower frame, each front wheel of the pair of front wheels being aligned with a respective one of the lower frame first lateral side and the lower frame second lateral side;
a pair of drive wheels being spaced from the pair of front wheels, the pair of drive wheels being positioned proximate to a junction between the lower frame and the upper frame, the lower frame being positioned between the pair of drive wheels wherein a first drive wheel of the pair of drive wheels is coupled to the lower frame first lateral side and wherein a second drive wheel of the pair of drive wheels is coupled to the lower frame second lateral side, the pair of drive wheels having a diameter exceeding a diameter of the pair of front wheels, the pair of drive wheels including:
a plurality of interchangeable wheels being releasably couplable to the lower frame wherein the plurality of interchangeable wheels are configured to facilitate movement of the lower frame and the lower frame across a plurality of terrains, the plurality of interchangeable wheels including:
a standard tire;
a treaded tire having a width exceeding a width of the standard tire, the treaded tire having a treaded surface; and
a smooth tire having a width exceeding a width of the treaded tire; and
a pair of rear wheels being spaced from the pair of drive wheels wherein the pair of drive wheels are positioned between the pair of front wheels and the pair of rear wheels, the pair of front wheels having a diameter exceeding a diameter of the pair of rear wheels, the pair of rear wheels being positioned beneath the upper frame when the upper frame is in the horizontal position wherein the pair of rear wheels are configured to inhibit the upper frame from tipping over when the upper frame is in the horizontal position;
a quick release pin releasably coupling each drive wheel of the pair of drive wheels to the lower frame, the quick release pin being engageable with a respective drive wheel of the pair of drive wheels and with the lower frame to releasably secure the respective drive wheel of the pair of drive wheels to the lower frame;
a brake being coupled to the lower frame, the brake being releasably engageable with the pair of drive wheels to inhibit rotation of the pair of drive wheels, the brake including:
a pair of brake levers each being pivotably coupled to a respective one of the lower frame first lateral side and the lower frame second lateral side;
a brake pad being coupled to each brake lever of the pair of brake levers, the brake pad being positionable against a respective drive wheel of the pair of drive wheels to inhibit the respective drive wheel from being rotated when each brake lever of the pair of brake levers is pivoted downwardly, the brake pad being spaced from the respective drive wheel of the pair of drive wheels to enable the respective drive wheel to be rotated when each brake lever of the pair of brake levers is pivoted upwardly;
a head rest being removably couplable to the upper frame, the head rest being positionable on the upper frame distally to the lower frame wherein the head rest is configured to support a head of the user, the head rest being parallel to the upper frame when the head rest is coupled to the upper frame;
a handle being coupled to and extending from the head rest, the handle being pivotably coupled to the head rest wherein the handle is pivotable between a lowered position, a raised position, and an intermediate position being between the lowered position and the raised position, the handle being perpendicular to the head rest when the handle is in the lowered position, the handle being parallel to the head rest when the handle is in the raised position, the handle being angled to extend outwardly and upwardly from the head rest when the handle is in the intermediate position, the handle including:
a pair of handle primary members, each handle primary member of the pair of handle primary members being aligned with a respective one of the upper frame first lateral side and the upper frame second lateral side when the head rest is coupled to the upper frame; and
a handle secondary member being coupled to and extending between the pair of handle primary members, the handle secondary member being nested within each handle primary member of the pair of handle primary members wherein the handle secondary member is extendable and retractable relative to each handle primary member of the pair of handle primary members to selectively adjust a length of the handle;
a handle lock being engageable with the handle and the head rest to releasably secure a position of the handle relative to the head rest wherein the handle lock is configured to secure the handle in the lowered position, the raised position, and the intermediate position, the handle lock including:
a first chamber being coupled to and extending outwardly from the handle;
a second chamber being pivotably coupled to the first chamber, the second chamber extending outwardly from the first chamber;
a button being coupled to the second chamber, the button being positioned on the second chamber distally to the first chamber, the button being actuatable to pivot the second chamber relative to the first chamber; and
a locking pin being coupled to the second chamber, the locking pin being engageable with the first chamber to inhibit the handle from being pivoted wherein actuation of the button pivots the second chamber to position the locking pin to engage the first chamber;
a support beam being coupled to the upper frame, the support beam being extendable between the upper frame first lateral side and the upper frame second lateral side wherein the support beam is configured to increase support for the user when the upper frame is in the horizontal position, the support beam being spaced from the junction between the lower frame and the upper frame, the support beam including:
a support beam first rod being pivotably coupled to the upper frame first lateral side, the support beam first rod including:
a hook being positioned distally to the upper frame first lateral side;
a support beam second rod being pivotably coupled to the upper frame second lateral side, the support beam second rod being releasably couplable to the support beam first rod to extend the support beam between the upper frame first lateral side and the upper frame second lateral side, the support beam second rod including:
a loop being positioned distally to the upper frame second lateral side, the hook engaging the loop to couple the support beam first rod to the support beam second rod; and
a sleeve being slidably coupled to the support beam second rod, the sleeve being positionable to cover the hook and the loop when the support beam first rod is coupled to the support beam second rod wherein the sleeve is configured to inhibit the hook from disengaging from the loop;
a lift mechanism being coupled to the upper frame and the lower frame to pivot the upper frame between the vertical position and the horizontal position, the lift mechanism comprising:
a pair of hydraulic pistons being coupled to the lower frame, each hydraulic piston of the pair of hydraulic pistons being positioned on a respective one of the lower frame first lateral side and the lower frame second lateral side;
a pair of lift levers being operably coupled to the pair of hydraulic pistons wherein actuation of the pair of lift levers directs air through the pair of hydraulic pistons to selectively pivot the upper frame between the vertical position and the horizontal position, each lift lever of the pair of lift levers being positioned on a respective one of the upper frame first lateral side and the upper frame second lateral side;
a pair of grips being coupled to and extending outwardly from the upper frame wherein the pair of grips are configured to facilitate movement of the upper frame and the lower frame when the upper frame is in the vertical position, each grip of the pair of grips being coupled to a respective lift lever of the pair of lift levers of the lift mechanism to facilitate actuation of the lift mechanism, the pair of grips being positioned between the support beam and the head rest when the head rest is coupled to the upper frame;
a pair of arm rests being coupled to the lower frame, each arm rest of the pair of arm rests extending upwardly from a respective one of the lower frame first lateral side and the lower frame second lateral side, the pair of brake levers of the brake being positioned adjacent to the pair of arm rests;
a pair of leg rests being releasably couplable to the lower frame wherein the pair of leg rests are removable from the lower frame to facilitate storage, the pair of leg rests being pivotably coupled to the lower frame, the pair of leg rests being coplanar with the lower frame when the pair of leg rests are pivoted upwards, the pair of leg rests being angled to extend downwardly and outwardly from the lower frame when the pair of leg rests are pivoted downwards, each leg rest of the pair of leg rests including:
a leg rest primary member;
a leg rest secondary member being nested within the leg rest primary member wherein the leg rest secondary member is extendable and retractable relative to the leg rest primary member to selectively adjust a length of each leg rest of the pair of leg rests;
a leg rest retainer being engageable with the leg rest primary member and the leg rest secondary member to releasably secure a position of the leg rest secondary member relative to the leg rest primary member, the leg rest retainer including:
a detent being mounted on the leg rest secondary member and extending through one of a plurality of aligned apertures extending through the leg rest primary member;
a foot rest plate being pivotably coupled to the leg rest secondary member, the foot rest plate extending outwardly from the leg rest secondary member; and
a calf pad being coupled to and extending outwardly from the leg rest primary member;
a leg support being coupled to the lower frame, the leg support being slidable outwardly from the lower frame wherein the leg support is selectively positionable to extend between the seat and the pair of leg rests when the pair of leg rests are pivoted upwards, the leg support including:
a track being coupled to the lower frame, the track being positioned beneath the seat, the track including:
a first rail being coupled to the lower frame first lateral side;
a second rail being coupled to the lower frame second lateral side;
a panel being slidably coupled to the track, the panel extending between the first rail and the second rail, the panel being slidable outwardly from beneath the seat along the track to position the panel between the seat and the pair of leg rests;
the lower frame, the upper frame, and the pair of leg rests being coplanar when the upper frame is in the horizontal position and when the pair of leg rests are pivoted upwards wherein the lower frame, the upper frame, and the pair of leg rests are configured to support the body of the user when the user is laying down;
a mattress pad being removably couplable to the lower frame, the upper frame, the head rest the pair of arm rests, and the pair of leg rests wherein the mattress pad is configured to be positionable between the body of the user and each of the lower frame, the upper frame, the head rest, the pair of arm rests, and the pair of leg rests, the mattress pad including:
a mattress head rest section being positionable on the head rest, the mattress head rest section including:
a pair of head rest section fasteners being coupled to and extending from opposing lateral sides of the mattress head rest section to releasably affix the mattress head rest section to the head rest;
a hanger section being pivotably coupled to the mattress head rest section, the hanger section extending outwardly from the mattress head rest section, the hanger section including a handle aperture being configured to receive the handle wherein the handle is positionable through the handle aperture to couple the mattress pad to the head rest, the hanger section comprising a fiber material being flexible wherein the fiber material is configured to facilitate the hanger section in pivoting upwardly and downwardly relative to the mattress head rest section;
a mattress back rest section being coupled to the mattress head rest section, the mattress back rest section being positioned distally on the mattress head rest section relative to the hanger section wherein the mattress back rest section is positionable on the upper frame, the mattress back rest section covering the back rest when the mattress back rest section is coupled to the upper frame, the mattress back rest section including:
a plurality of back rest fasteners being coupled to and extending from opposing lateral sides of the mattress back rest section wherein each back rest fastener of the plurality of back rest fasteners is configured to releasably engage a respective one of the upper frame first lateral side and the upper frame second lateral side to releasably affix the mattress back rest section to the upper frame;
a mattress seat rest section being coupled to the mattress back rest section distally to the mattress head rest section wherein the mattress seat rest section is positionable on the lower frame, the mattress seat rest section extending from the mattress back rest section wherein the mattress seat rest section is positionable to cover the seat when the mattress seat rest section is coupled to the lower frame;
a pair of arm rest covers being pivotably coupled to opposing lateral edges of the mattress seat rest section wherein the pair of arm rest covers are configured to be positionable over the pair of arm rests, the pair of arm rest covers comprising the fiber material being flexible wherein the fiber material is configured to facilitate the pair of arm rest covers in pivoting upwardly and downwardly relative to the mattress seat rest section;
a pair of mattress leg rest sections being pivotably coupled to the mattress seat rest section distally to the mattress back rest section wherein the pair of mattress leg rest sections are positionable on the pair of leg rests, the pair of mattress leg rest sections covering the calf pad of each of the pair of pair of leg rests when the pair of mattress leg rest sections are coupled to the pair of leg rests; and
a pair of foot sleeves being coupled to the pair of mattress leg rest sections distally to the mattress seat rest section wherein the foot rest plate of each leg rest of the pair of leg rests is positionable within a respective foot sleeve of the pair of foot sleeves;
a pair of motors being operably coupled to the pair of drive wheels wherein the pair of motors are actuatable to rotate the pair of drive wheels and wherein the pair of motors are configured to facilitate movement of the lower frame and the upper frame, the pair of motors being actuatable to pivot the pair of drive wheels wherein the pair of motors are configured to direct movement of the lower frame and the upper frame;
a motor power source being electrically coupled to the pair of motors, the motor power source being a pair of rechargeable batteries;
a charging port being electrically coupled to the motor power source wherein the charging port is configured to facilitate transfer of power from an external power source to the motor power source, the charging port being inset into the motor power source, the charging port being exposed within the motor power source;
a motor processor being electrically coupled to the motor power source, the motor processor being electrically coupled to the pair of motors wherein the motor processor is actuatable to actuate the pair of motors, the motor processor being positioned within the first motor of the pair of motors;
a control assembly being in wireless communication with the motor processor wherein the control assembly is actuatable to signal the motor processor to actuate the pair of motors, the control assembly including:
a joystick being removably couplable to a selectable arm rest of the pair of arm rests, the joystick including:
a clamp being positionable to engage the selectable arm rest of the pair of arm rests;
a pole being coupled to and extending upwardly from the clamp;
a wrist pad being coupled to and extending outwardly from the pole, the wrist pad having a planar upper surface wherein the wrist pad is configured to support a wrist of the user;
a joystick housing being coupled to and extending outwardly from the wrist pad;
a joystick processor being positioned within the joystick housing;
a joystick power source being electrically coupled to the joystick processor, the joystick power source being a battery, the battery being rechargeable; and
a joystick transmitter being electrically coupled to the joystick processor wherein the joystick transmitter sends signals from the joystick processor to the motor processor;
a joystick directional control panel being positioned on the joystick housing wherein the joystick directional control panel is configured to be accessible to the user while the wrist of the user is supported on the wrist pad, the joystick directional control panel being actuatable to signal the pair of motors to pivot the pair of drive wheels to direct movement of the upper frame and the lower frame;
a joystick speed control panel being positioned on the joystick housing wherein the joystick speed control panel is configured to be accessible to the user while the wrist of the user is supported on the wrist pad, the joystick speed control panel being actuatable to selectively adjust a speed at which the pair of motors rotate the pair of drive wheels;
a joystick power button being actuatable to turn the pair of motors on and off, the joystick power button being positioned on the joystick housing wherein the joystick power button is configured to be accessible to the user while the wrist of the user is supported on the wrist pad;
a joystick horn button being positioned on the joystick housing wherein the joystick horn button is configured to be accessible to the user while the wrist of the user is supported on the wrist pad, the joystick horn button being actuatable to signal the joystick processor to emit a horn sound being stored on the joystick processor; and
a joystick speaker being electrically coupled to the joystick processor wherein the joystick processor is actuatable to audibly emit the horn sound through the joystick speaker;
a remote including:
a remote housing;
a remote processor being positioned within the remote housing;
a remote power source being electrically coupled to the remote processor, the remote power source being a battery, the battery being rechargeable; and
a remote transmitter being electrically coupled to the remote processor wherein the remote transmitter sends signals from the remote processor to the motor processor;
a remote directional control panel being positioned on the remote housing wherein the remote directional control panel is configured to be accessible to the user while the user is holding the remote housing, the remote directional control panel being actuatable to signal the pair of motors to pivot the pair of drive wheels to direct movement of the upper frame and the lower frame;
a remote speed control panel being positioned on the remote housing wherein the remote speed control panel is configured to be accessible to the user while the user is holding the remote housing, the remote speed control panel being actuatable to selectively adjust a speed at which the pair of motors rotate the pair of drive wheels;
a remote power button being actuatable to turn the pair of motors on and off, the remote power button being positioned on the remote housing wherein the remote power button is configured to be accessible to the user while the user is holding the remote housing;
a remote horn button being positioned on the remote housing wherein the remote horn button is configured to be accessible to the user while the user is holding the remote housing, the remote horn button being actuatable to signal the remote processor to emit a horn sound being stored on the remote processor; and
a remote speaker being electrically coupled to the remote processor wherein the remote processor is actuatable to audibly emit the horn sound through the remote speaker;
a motor transceiver being electrically coupled to the motor processor, the motor transceiver being in wireless communication with the control assembly wherein the motor transceiver is configured to send signals to the control assembly and receive signals from the control assembly to actuate the motor processor, the motor transceiver being positioned within the first motor of the pair of motors; and
a motor receiver being electrically coupled to the motor processor, the motor receiver being in wireless communication with the motor transceiver wherein the motor receiver is configured to receive signals from the motor transceiver, the motor receiver being positioned within the second motor of the pair of motors.
